(19) United States
(12) Patent Application Publication
(10) Pub. No.: US 2004/0136026 A1
(43) Pub. Date: Jul. 15, 2004

(54) System and method for transferring image data to a plurality of agents

(76) Inventors: David J. Park, Torrance, CA (US); Vincent Wu, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/340,169

(22) Filed: Jan. 10, 2003

(51) Int. Cl. G06F 3/05; G06F 13/00; G06F 15/00; H04N 1/40

(52) U.S. Cl. 358/1.15; 358/444

(57) ABSTRACT

This invention is directed to a system and method for transferring image data to a plurality of agents. More particularly, this invention is directed to a system and method for transferring image data from a document reading device, such as a scanning device, to a plurality of agents.

### BACKGROUND OF THE INVENTION

This invention is directed to a system and method for transferring image data to a plurality of agents. More particularly, this invention is directed to a system and method for transferring image data from a document reading device, such as a scanning device, to a plurality of agents.

Typically, when a user uses a scanner, copier, or other document reading device, the generated image data is saved to shared network drives to be processed further. In order to perform further processing the user has to access the image data from the shared network drive and then go through a cumbersome process to move the data to a local workstation after the data is generated. For example, if a user wants to send the image data to an optical character recognition device and to an electronic mail server, the user must move the data to a device that has the optical character recognition capability and then must also send the data to the electronic mail server. The user must engage in these intermediate steps for each device or agent to which the user wants to send the image or have the image processed.

There is a need for a system and method for easily transferring image data from a document reading device to a plurality of different agents for processing.

### SUMMARY OF THE INVENTION

In accordance with the present invention, there is provided a system and method for easily transferring image data from a document reading device to a plurality of different agents.

Further, in accordance with the present invention, there is provided a system and method for multiple processing of image data received from a document reading device.

Still further, in accordance with the present invention, there is provided a system for transferring image data from a document reading device to a plurality of agents. The system comprises means adapted for receiving image data from an associated document reading device. The system also comprises means adapted for selecting an associated data transfer signal for each associated agent, wherein each data transfer signal includes data representative of a selected data transfer format and wherein the selected data transfer format is the same for each agent. The system further comprises means adapted for transmitting the image data via a data transfer system from an associated document reading device to each associated agent in accordance with the data transfer selection signal for each agent, wherein the image data is transmitted sequentially from the document reading device to each agent.

In one embodiment, the system further comprises means adapted for transmitting image data from the document reading device to a document reading device controller, and means adapted for transmitting the image data from the document reading device controller to each associated agent in accordance with the data transfer signal for each agent. Preferably, the document reading device controller includes at least one selected data storage area, the image data is transmitted from the document reading device into the at least one selected data storage area, and the image data is transmitted from the at least one selected data storage area to each agent in accordance with the data transfer signal for each agent.

Still further, in accordance with the present invention, there is provided a method for transferring image data from a document reading device to a plurality of agents. The method comprises receiving image data from an associated document reading device and selecting an associated data transfer signal for each associated agent, wherein each data transfer signal includes data representative of a selected data transfer format and wherein the selected data transfer format is the same for each agent. The method also comprises transmitting the image data via a data transfer system from an associated document reading device to each associated agent in accordance with the data transfer selection signal for each agent, wherein the image data is transmitted sequentially from the document reading device to each agent.

In one embodiment, the method further comprises the steps of: transmitting image data from the document reading device to a document reading device controller, and transmitting the image data from the document reading device controller to each associated agent in accordance with the data transfer signal for each agent. Preferably, the document reading device controller includes at least one selected data storage area, the image data is transmitted from the document reading device into the at least one selected data storage area, and the image data is transmitted from the at least one selected data storage area to each agent in accordance with the data transfer signal for each agent.

Advantages of the system and method of the present invention, include, but are not limited to, the ability to easily transfer image data between a document reading device and a plurality of agents and the ability for multiple processing of image data.

These and other advantages, aspects, and features will be understood by one of ordinary skill in the art upon reading and understanding the specification.

### BRIEF DESCRIPTION OF THE DRAWINGS

FIG. 1 is a block diagram illustrating the preferred embodiment of the system according to the present invention.

FIG. 2 shows a sample template for selecting the desired settings for the document reading device.

FIG. 3 shows a sample template for enabling the system to transmit the image data to a plurality of multiple agents.

FIG. 4 shows a sample template for associating agents with a user's mailbox.

FIG. 5 shows a sample template for selecting the desired data transfer signal for transmitting the generated image data to an FTP server.

FIG. 6 shows a sample template for selecting the desired data transfer signal for transmitting the generated image data to a TWAIN agent.

FIG. 7 shows a sample template for selecting the desired data transfer signal for transmitting the generated image data to a file.

FIG. 8 shows a sample template for selecting the desired data transfer signal for transmitting the generated image data to an electronic mail address.

FIG. 9 shows a sample template for selecting the desired data transfer signal for transmitting the generated image data to a facsimile device.

FIG. 10 shows a sample template for selecting the desired data transfer signal for transmitting the generated image data to a folder.

### DETAILED DESCRIPTION OF THE PREFERRED EMBODIMENT

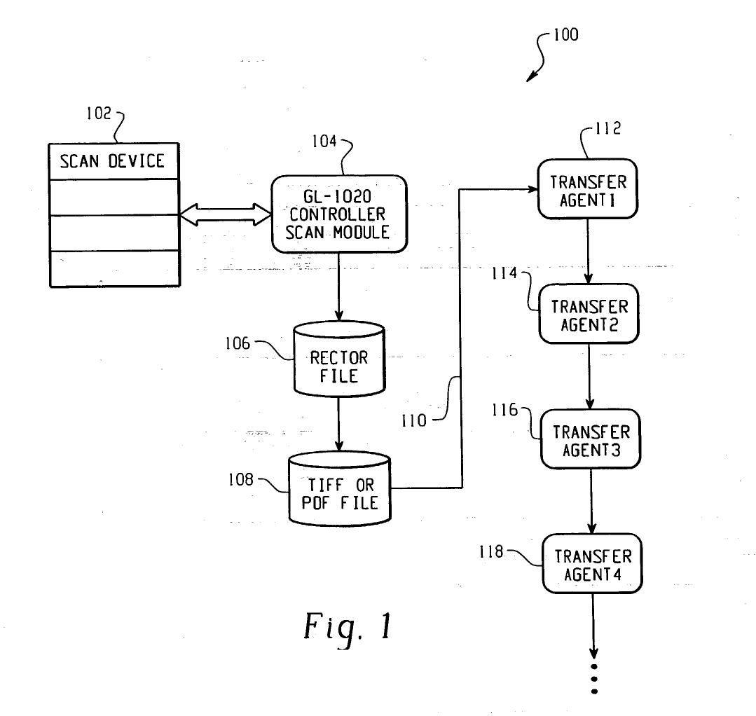

The present invention is directed to a system and method for transferring image data from a document reading device to a plurality of agents. FIG. 1 shows a block diagram preferred embodiment of the system according to the present invention generally designated as 100. The system comprises a document reading device 102, such as a scanner or copier, for generating image data. The document reading device is any suitable document reading device known in the art. Preferably, the document reading device is a scanning device, a copying device, and a facsimile device. More preferably, the document reading device is a scanning device or a facsimile device. Suitable commercially available document reading devices include, but are not limited to, the Toshiba e-Studio Series Controller. The document reading device further comprises a controller 104 which controls the functions of the document reading device and includes storage means for storing the image data.

In operation, the user inputs the document or other data into the document reading device to generate the image data and selects the desired settings for generating the image data. The image data is stored as a rector file 106 on the controller or any other suitable memory device. The image data is then converted by the controller to an appropriate format, such as TIFF or PDF, as shown by 108. The same format is used for each agent. A Transfer Agent is used to access the image data on the controller. A data transfer session is initiated on the communication link 110 whereupon the image data is transferred sequentially to the each agent via a data transfer system. The communication link is comprised of one or more segments of wired or wireless communications.

In a preferred embodiment, there is a Transfer Agent for each agent as shown by 112, 114, 116, and 118 in FIG. 1. In one embodiment, the image data is sent from the document reading device to each agent in the order determined by the document reading device. In another embodiment, the image data is sent from the document reading device to the each agent in the order determined by the preceding transfer agent. As shown in FIG. 1, the image data is sent from the document reading device to a first Transfer Agent 112 in accordance with the data transfer signal. The image is then sent from the first Transfer Agent to a second Transfer Agent 114 in accordance with the data transfer signal.

In a preferred embodiment, the document reading device controller includes at least one data storage area or mailbox. In this embodiment, the image data is received into the at least one data storage area and is transmitted to the plurality of agents from the at least one data storage area. In a more preferred embodiment, the at least one data storage area is associated with at least one system user. The user selects the data storage area to receive image data. The user identifies the appropriate data storage area by providing selected information about the data storage area in any manner known in the art. Such information includes, but is not limited to, data storage area location, data storage area name, access permission, user name associated with the data storage area, and user name password. The information provided by the user is then verified, and if so, the user is allowed to access the data storage area to receive the image data and transfer the image data to the plurality of agents.

The controller 104 includes means adapted for selecting the desired settings for generating the image data and means adapted for selecting a desired data transfer signal for each agent for transferring the image.

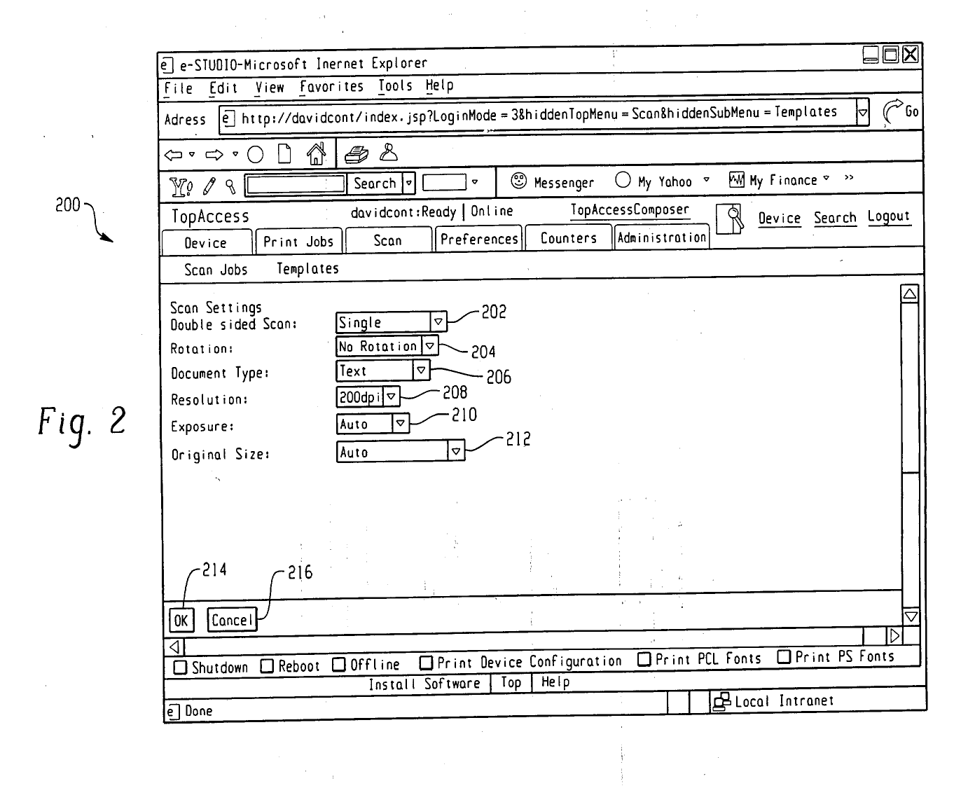

FIG. 2 shows a preferred sample screen display 200 for selecting the desired settings for generating the image data. The user selects whether it is a double-sided scan image at 202. The user then specifies the rotation at 204, the document type at 206, the resolution at 208, the exposure at 210, and the size of the original at 212. The user can then select the OK button 214 to save the settings or the Cancel button 216 to cancel the settings entered.

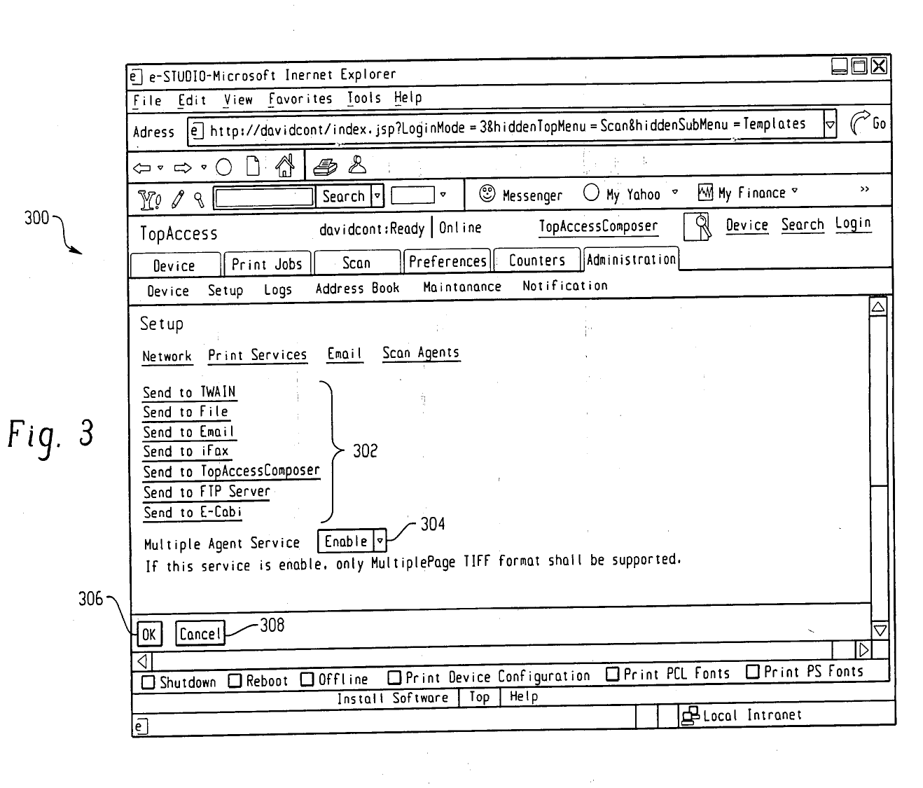

FIG. 3 shows a preferred sample screen display 300 for enabling the system to transmit the image data to a plurality of agents. The region specified at 302 shows the various agents which may be receive image data from the document reading device. To enable the system to transmit the image data to a plurality of agents, the user selects that option at 304. Once this option is enabled, the system will only transmit the image data to the plurality of agents selected in a single file format. Preferably, the image data is transmitted to the plurality of agents selected in Multiple Page TIFF format. Once the user has selected this option, the user can then select the OK button 306 to save the setting or the Cancel button 308 to cancel the settings entered.

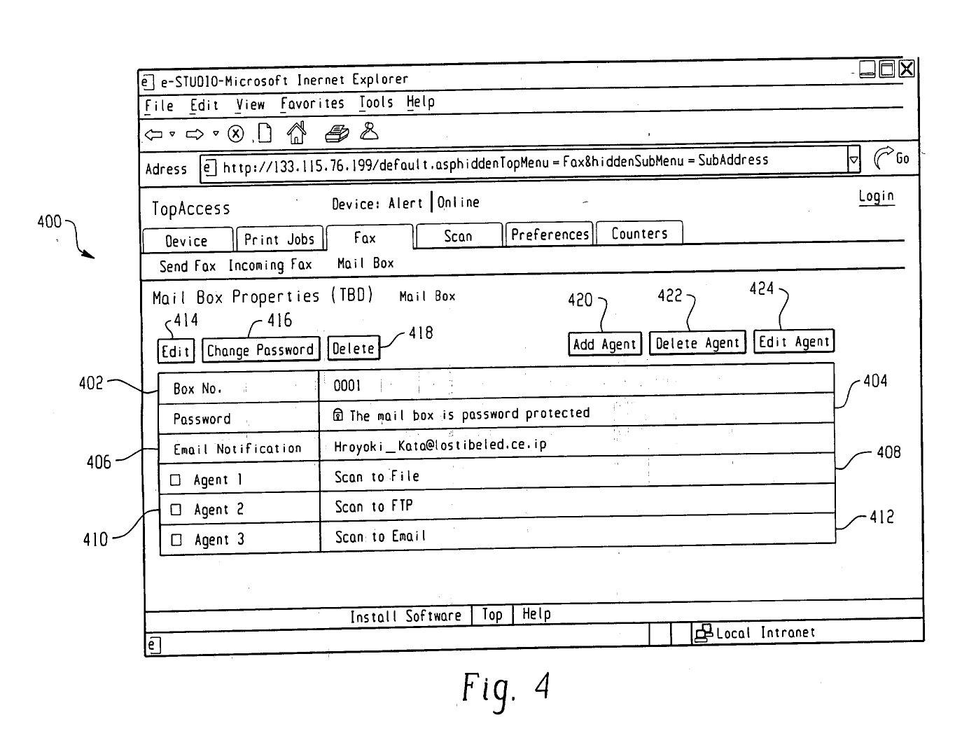

FIG. 4 shows a preferred sample screen display 400 for setting up a mailbox on the document reading device controller to receive image data and to associate agents with the mailbox to receive image data from the mailbox. The associated agents include any suitable agents to which data may be transmitted from the document reading device. Suitable agents include, but are not limited to, storage repositories, servers, image generating devices, and optical character recognition systems. The screen provides information about the mailbox, such as the mailbox number 402, whether the mailbox is password protected 304, whether the user desires electronic mail notification as to the status of the transfer 306, and information about the associated agents 408, 410, 412. The user may edit the mailbox properties by selecting the Edit button 414. The user then is allowed to edit the various properties associated with the mailbox. The user may change the password associated with the mailbox by selecting the Change Password button 416. The user is then prompted to change the password. The user may delete the mailbox by selecting the Delete button 418. The mailbox is then deleted from the document reading device controller.

The user may add agents to be associated with the mailbox by selecting the Add Agent button 420. The user is then prompted as to which agent it wants to add and directed to the appropriate template for selecting the desired data transfer signal for transmitting the image data to such agent. The user may delete an agent by selecting the Delete Agent button 422 and then selecting the agent or agents to be deleted. The user may edit the desired data transfer signal for an agent by selecting the Edit Agent button 424. The user then selects the agent to edit and is direct to the appropriate template for editing the desired transfer signal.

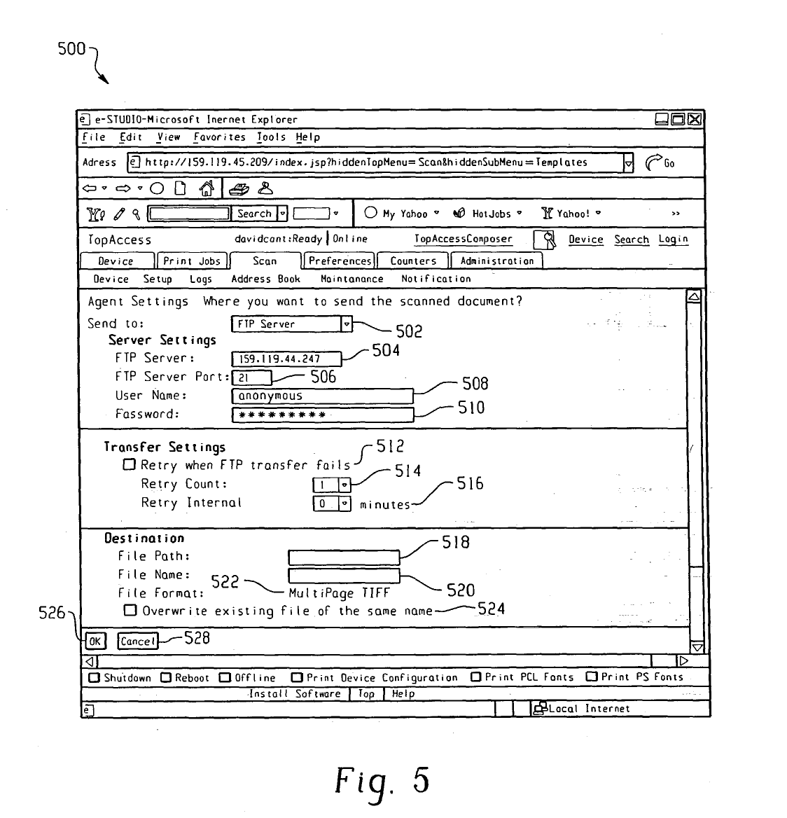

A preferred sample screen display 500 for selecting the desired data transfer signal for transmitting the generated image data to a FTP server is shown in FIG. 5. The desired agent to which the image data should be sent as shown at 502. The user then specifies the server settings by selecting the file server 504 and the file server port 506 to which the image data is to be transferred. The user then inputs his username 508 and password on the file server account 510. The user then selects the transfer settings by selecting the option to retry when the transfer fails 512. If the user selects to retry should the transfer fail, the user then inputs the retry count 514 and the retry interval 516. The user then provides the destination parameters by specifying the file path 518 and the file name 520 for the image data. The file format selected when enabling the system to transmit image data to a plurality of agents as shown in FIG. 2 is shown at 522. Preferably the file format is Multiple Page TIFF. The user can also select whether to overwrite an existing file of the same name by checking the box shown as 524. The user can then select the OK button 526 to save the settings or the Cancel button 528 to cancel the settings entered.

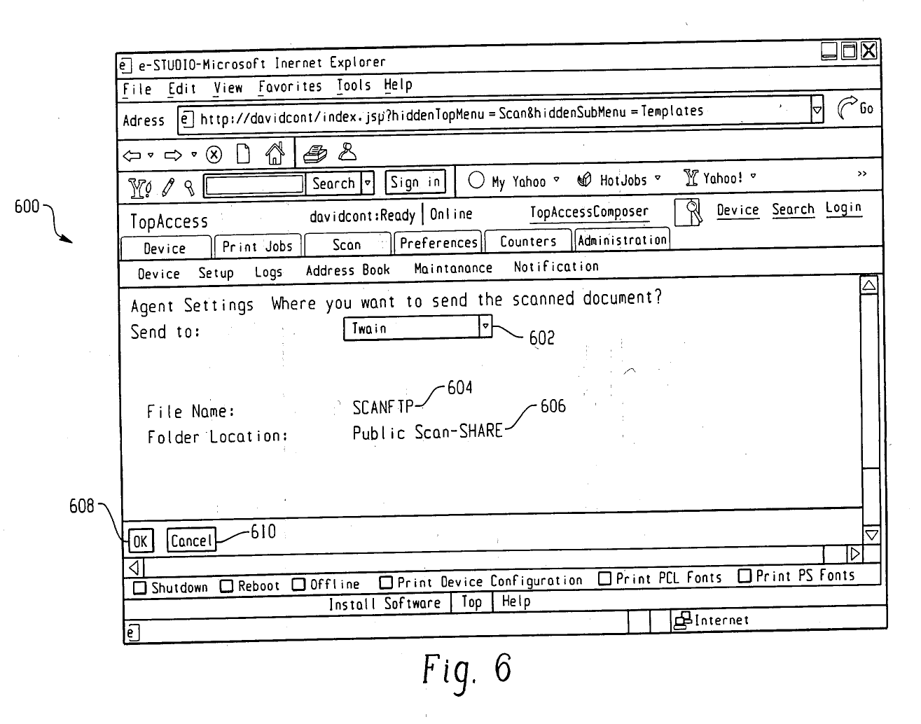

A preferred sample screen display 600 for selecting the desired transfer signal for transmitting the generated image data to a TWAIN agent is shown in FIG. 6. The desired agent to which the image data should be send it shown as 602. The user then specifies the file name 604 and the folder location 606 to which the image data is to be sent. The user can then select the OK button 608 to save the settings or the Cancel button 510 to cancel the settings entered. The file format selected when enabling the system to transmit image data to a plurality of agents as shown in FIG. 2 is not shown on this screen. Preferably the file format is Multiple Page TIFF.

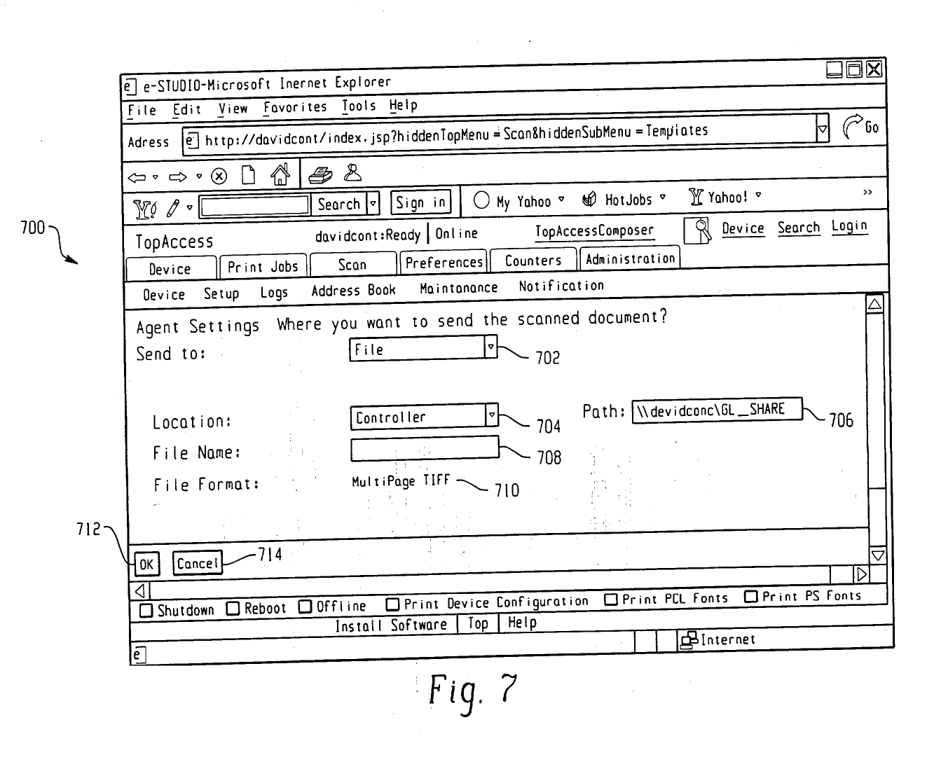

A preferred sample screen display 700 for selecting the desired data transfer signal for transmitting the generated image data to a file is shown in FIG. 7. The desired agent to which the image data should be send it shown as 702. The user then specifies the location of the file 704, the file path 706, and the file name 708. The file format selected when enabling the system to transmit image data to a plurality of agents as shown in FIG. 2 is shown at 710. Preferably the file format is Multiple Page TIFF. The user can then select the OK button 712 to save the settings or the Cancel button 714 to cancel the settings entered.

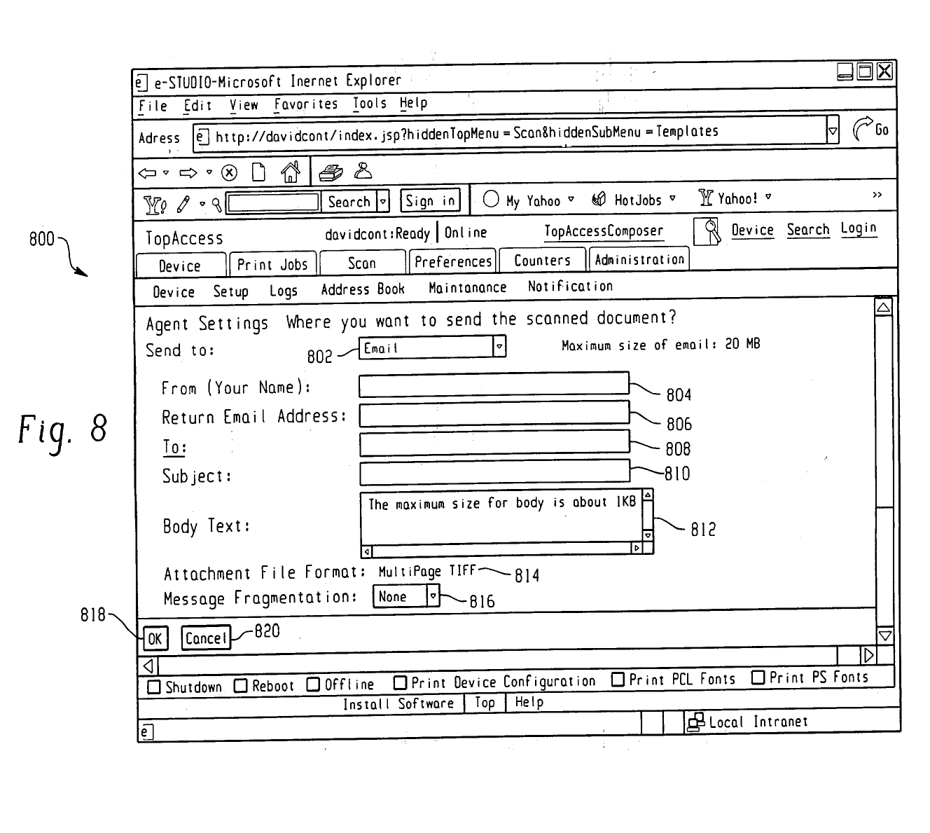

FIG. 8 shows a preferred sample screen display 800 for selecting the desired data transfer signal for transmitting the generated image data to an electronic mail address. The desired agent to which the image data should be sent is shown as 802. The user then enters the name of the person from whom the mail is sent 804, the return electronic mail address 806, the name to whom the mail is be sent 808, the subject of the mail 810, and any text to accompany the mail 812. The file format selected when enabling the system to transmit image data to a plurality of agents as shown in FIG. 2 is shown at 814. Preferably the file format is Multiple Page TIFF. The user can also specify whether there is to be any message fragmentation 816. The user can then select the OK button 818 to save the settings or the Cancel button 820 to cancel the settings entered.

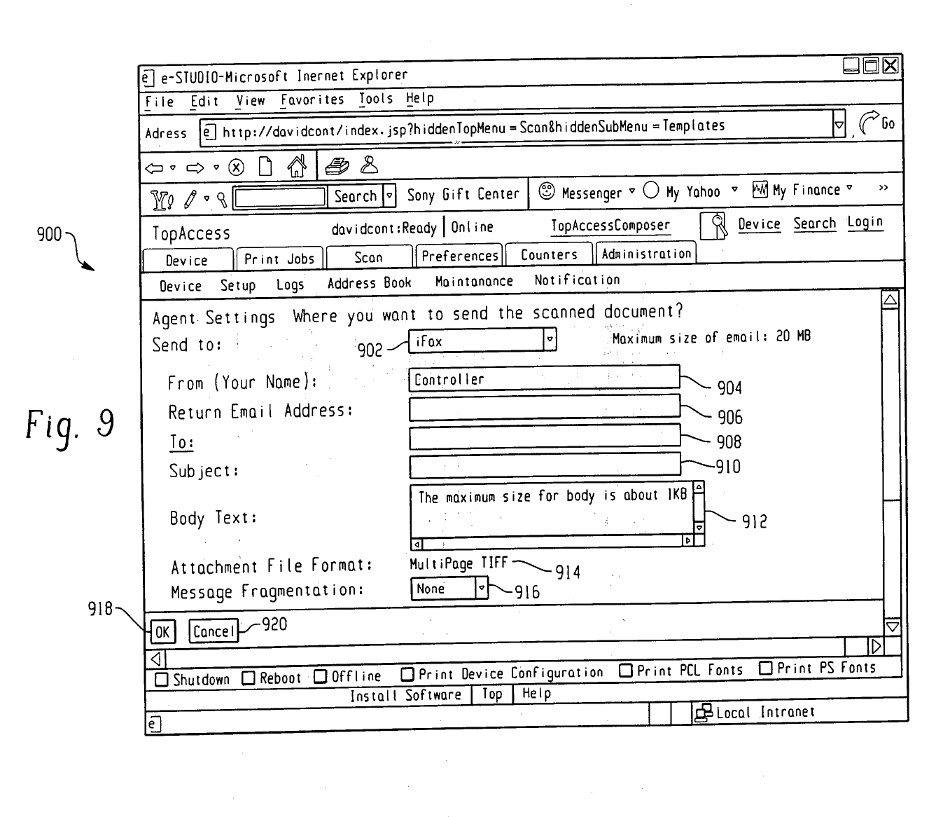

FIG. 9 shows a preferred sample screen display 900 for selecting the desired data transfer signal for transmitting the generated image data to facsimile device. The desired agent to which the image data should be sent is shown as 902. The user then enters the name of the person from whom the facsimile is sent 904, the return electronic mail address 906, the name to whom the facsimile is be sent 908, the subject of the facsimile 910, and any text to accompany the facsimile 912. The file format selected when enabling the system to transmit image data to a plurality of agents as shown in FIG. 2 is shown at 914. Preferably the file format is Multiple Page TIFF. The user can also specify whether there is to be any message fragmentation 916. The user can then select the OK button 918 to save the settings or the Cancel button 920 to cancel the settings entered.

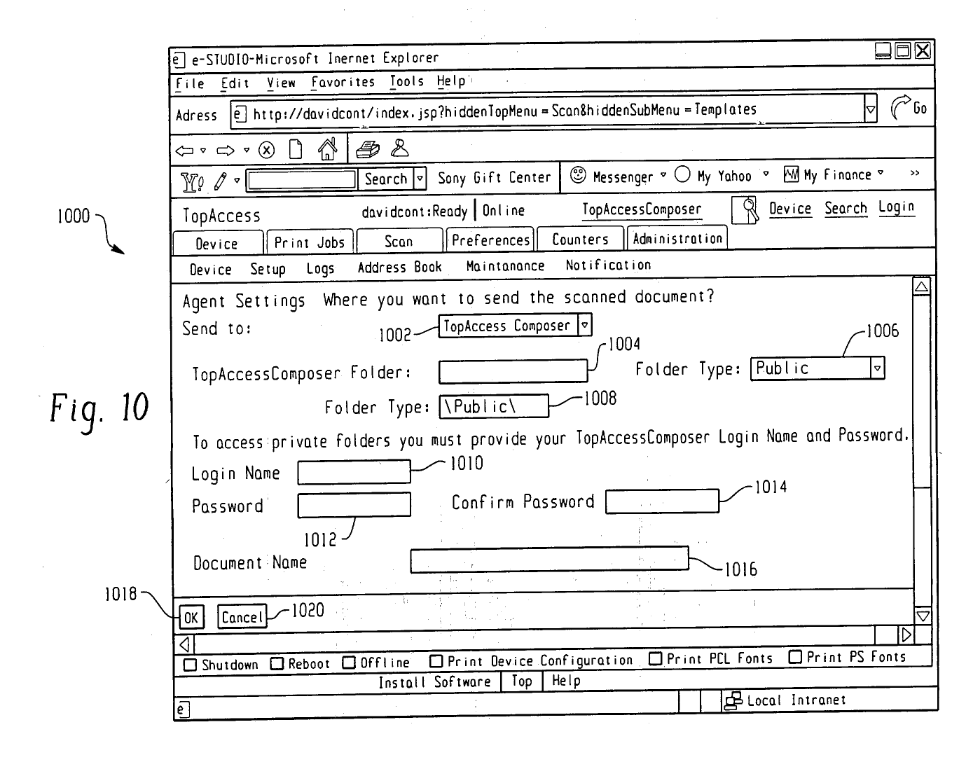

FIG. 10 shows a preferred sample screen display 1000 for selecting the desired data transfer signal for transmitting the generated image data to folder or other storage repository. The desired agent to which the image data should be send is shown as 1002. The user the specifies the folder name 1004, the type of folder 1006, and the folder path 1008. If the user selects a private folder, then the user must provide the user's login name 1010 and the user's password to access the folder 1012. The user must also reenter or confirm his password as shown as 1014. The user then provides the name of the document as shown as 1016. The user can then select the OK button 1018 to save the settings or the Cancel button 1020 to cancel the settings entered. The file format selected when enabling the system to transmit image data to a plurality of agents as shown in FIG. 2 is not shown on this screen. Preferably the file format is Multiple Page TIFF.

Once the user has selected all of the agents to which the generated image data is to be sent, the user initiates the process and the controller 104 begins the process of transferring the image data to the associated agents. Electronic mail notifications as to the status and any errors are also sent to the user as described above.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A system for transferring image data from a document reading device to a plurality of associated agents comprising:
means adapted for receiving image data from an associated document reading device;
means adapted for selecting an associated data transfer signal for each associated agent, wherein each data transfer signal includes data representative of a selected data transfer format and wherein the selected data transfer format is the same for each agent; and
means adapted for transmitting the image data via a data transfer system from an associated document reading device to each associated agent in accordance with the data transfer selection signal for each agent, wherein the image data is transmitted sequentially from the document reading device to each agent.

2. The system according to claim 1 wherein the sequence for transmitting the image data to each agent is determined by the document reading device.

3. The system according to claim 1 wherein the sequence for transmitting the image data to each agent is determined by each preceding agent.

4. The system according to claim 1 further comprising:
means adapted for transmitting image data from the document reading device to a document reading device controller, and
means adapted for transmitting the image data from the document reading device controller to each associated agent in accordance with the data transfer signal for each agent.

5. The system according to claim 4 wherein the document reading device controller includes at least one selected data storage area, the image data is transmitted from the document reading device into the at least one selected data storage area, and the image data is transmitted from the at least one selected data storage area to each agent in accordance with the data transfer signal for each agent.

6. The system according to claim 5 further comprising means adapted for associating the at least one data storage area with at least one associated user.

7. The system according to claim 6 further comprising:
means adapted for prompting an associated user for selected information about the at least one data storage area; and
means adapted for receiving from the associated user selection data designating a user-selected data storage area after prompting the user.

8. The system according to claim 4 wherein the selected information includes at least one of data storage area location, data storage area name, access permission, user name associated with the data storage area, and user name password.

9. The system according to claim 2 wherein the document reading device controller comprises means adapted to convert the image data to a selected format prior to transmitting the image data to each associated agent.

10. The system according to claim 9 wherein the document reading device controller comprises means adapted to first convert the image data to rector format and to then convert the image data to the selected format.

11. The system according to claim 1 further comprising means adapted for selecting parameters for generating the image data.

12. The system according to claim 1 wherein the data transfer format is selected from the group consisting of TIFF and PDF.

13. The system according to claim 1 wherein the document reading device is an image generating device.

14. The system according to claim 1 wherein the associated agents include storage repositories, servers, image generating devices, and optical character recognition systems.

15. A method for transferring image data from a document reading device to a plurality of associated agents comprising the steps of:
receiving image data from an associated document reading device;
selecting an associated data transfer signal for each associated agent, wherein each data transfer signal includes data representative of a selected data transfer format and wherein the selected data transfer format is the same for each agent; and
transmitting the image data via a data transfer system from an associated document reading device to each associated agent in accordance with the data transfer selection signal for each agent, wherein the image data is transmitted sequentially from the document reading device to each agent.

16. The method according to claim 15 wherein the sequence for transmitting the image data to each agent is determined by the document reading device.

17. The method according to claim 15 wherein the sequence for transmitting the image data to each agent is determined by each preceding agent.

18. The method according to claim 15 further comprising the steps of:
transmitting image data from the document reading device to a document reading device controller, and
transmitting the image data from the document reading device controller to each associated agent in accordance with the data transfer signal for each agent.

19. The method according to claim 18 wherein the document reading device controller includes at least one selected data storage area, the image data is transmitted from the document reading device into the at least one selected data storage area, and the image data is transmitted from the at least one selected data storage area to each agent in accordance with the data transfer signal for each agent.

20. The method according to claim 15 further comprising the step of associating the at least one data storage area with at least one associated user.

21. The method according to claim 20 further comprising the steps of:
prompting an associated user for selected information about the at least one data storage area; and
receiving from the associated user selection data designating a user-selected data storage area after prompting the user.

22. The method according to claim 21 wherein the selected information includes at least one of data storage area location, data storage area name, access permission, user name associated with the data storage area, and user name password.

23. The method according to claim 18 further comprising the step of converting the image data by the document reading device controller to a selected format prior to transmitting the image data to each associated agent.

24. The method according to claim 23 wherein the image data is first converted to rector format and the image data is then converted to the selected format.

25. The method according to claim 15 further comprising the step of selecting parameters for generating the image data.

26. The method according to claim 15 wherein the data transfer format is selected from the group consisting of TIFF and PDF.

27. The method according to claim 15 wherein the document reading device is an image generating device.

28. The method according to claim 15 wherein the associated agents include storage repositories, servers, image generating devices, and optical character recognition systems.

29. A computer-readable medium of instruction for transferring image data from a document reading device to a plurality of associated agents comprising:
means adapted for receiving image data from an associated document reading device;
means adapted for selecting an associated data transfer signal for each associated agent, wherein each data transfer signal includes data representative of a selected data transfer format and wherein the selected data transfer format is the same for each agent; and
means adapted for transmitting the image data via a data transfer system from an associated document reading device to each associated agent in accordance with the data transfer selection signal for each agent, wherein the image data is transmitted sequentially from the document reading device to each agent.

30. The computer-readable medium according to claim 29 wherein the sequence for transmitting the image data to each agent is determined by the document reading device.

31. The computer-readable medium according to claim 29 wherein the sequence for transmitting the image data to each agent is determined by each preceding agent.

32. The computer-readable medium according to claim 29 further comprising:
means adapted for transmitting image data from the document reading device to a document reading device controller, and
means adapted for transmitting the image data from the document reading device controller to each associated agent in accordance with the data transfer signal for each agent.

33. The computer-readable medium according to claim 32 wherein the document reading device controller includes at least one selected data storage area, the image data is transmitted from the document reading device into the at least one selected data storage area, and the image data is transmitted from the at least one selected data storage area to each agent in accordance with the data transfer signal for each agent.

34. A computer-implemented method for transferring image data from a document reading device to a plurality of associated agents comprising the steps of:
receiving image data from an associated document reading device;
selecting an associated data transfer signal for each associated agent, wherein each data transfer signal includes data representative of a selected data transfer format and wherein the selected data transfer format is the same for each agent; and
transmitting the image data via a data transfer system from an associated document reading device to each associated agent in accordance with the data transfer selection signal for each agent, wherein the image data is transmitted sequentially from the document reading device to each agent.

35. The computer-implemented method according to claim 34 wherein the sequence for transmitting the image data to each agent is determined by the document reading device.

36. The computer-implemented method according to claim 34 wherein the sequence for transmitting the image data to each agent is determined by each preceding agent.

37. The computer-implemented method according to claim 34 further comprising the steps of:
transmitting image data from the document reading device to a document reading device controller, and
transmitting the image data from the document reading device controller to each associated agent in accordance with the data transfer signal for each agent.

38. The computer-implemented method according to claim 37 wherein the document reading device controller includes at least one selected data storage area, the image data is transmitted from the document reading device into the at least one selected data storage area, and the image data is transmitted from the at least one selected data storage area to each agent in accordance with the data transfer signal for each agent.
